(19) United States
(12) Patent Application Publication
(10) Pub. No.: US 2020/0034550 A1
(43) Pub. Date: Jan. 30, 2020

(54) SYSTEM AND METHOD TO PROTECT DATA PRIVACY OF LIGHTWEIGHT DEVICES USING BLOCKCHAIN AND MULTI-PARTY COMPUTATION

(71) Applicant: HRL Laboratories, LLC, Malibu, CA (US)

(72) Inventors: Hyun (Tiffany) J. Kim, Irvine, CA (US); Joshua D. Lampkins, Gardena, CA (US)

(21) Appl. No.: 16/444,582

(22) Filed: Jun. 18, 2019

Related U.S. Application Data
(60) Provisional application No. 62/711,304, filed on Jul. 27, 2018.
(60) Provisional application No. 62/801,581, filed on Feb. 5, 2019.

(51) Int. Cl. G06F 21/60; H04L 9/08; H04L 9/32

(52) U.S. Cl. CPC G06F 21/602; H04L 9/0819; H04L 2209/46; H04L 9/3242; H04L 2209/38; H04L 9/0861

(57) ABSTRACT

Described is a system for improving data privacy in Internet of Things (IoT) devices. The system includes an IoT device having data stored thereon, one or more blockchain nodes in communication with the IoT device, and one or more multi-party computation (MPC) nodes in communication with the IoT device and the one or more blockchain nodes. The data is encrypted using a blockchain process, and a symmetric key for the encrypted data is securely distributed via a MPC process to a data recipient.

### CROSS-REFERENCE TO RELATED APPLICATIONS

The present application is a Non-Provisional application of U.S. Provisional Application No. 62/711,304, filed in the United States on Jul. 27, 2018, entitled, “Systems and Methods to Protect Data Privacy of Lightweight Devices Using Blockchain and Multi-Party Computation,” the entirety of which is incorporated herein by reference.

The present application is ALSO a Non-Provisional application of U.S. Provisional Application No. 62/801,581, filed in the United States on Feb. 5, 2019, entitled, “System and Methods to Protect Data Privacy of Lightweight Devices Using Blockchain and Multi-Party Computation,” the entirety of which is incorporated herein by reference.

### BACKGROUND OF INVENTION

### (1) Field of Invention

The present invention relates to a system for improving data privacy and, more particularly, to a system for improving data privacy using blockchain and multi-party computation.

### (2) Description of Related Art

Secure multi-party computation (MPC) is a subfield of cryptography with the goal of creating methods for parties to jointly compute a function over their inputs while keeping those inputs private. Unlike traditional cryptographic tasks, the adversary in this model controls actual participants. A blockchain is a collection of data that is segregated into a list of blocks. Each block is cryptographically linked to the previous block in such a way that one cannot edit a block without editing all subsequent blocks.

Enigma (see Literature Reference No. 1 of the List of Incorporated Literature References) combines blockchain technology with MPC to support fully homomorphic encryption such that entities can query encrypted data. Enigma uses blockchain to maintain the location of the encrypted secret shares for MPC, which protects the privacy of the stored data. However, Enigma suffers from computationally expensive cryptographic operations to query encrypted data, resulting in increased overhead on the order of 100× compared to querying non-encrypted data.

Thus, a continuing need exists for a system to improve data privacy using blockchain and MPC without requiring querying over encrypted data.

### SUMMARY OF INVENTION

The present invention relates to a system for improving data privacy and, more particularly, to a system for improving data privacy using blockchain and multi-party computation. The system comprises an Internet of Things (IoT) device having data stored thereon, one or more blockchain nodes in communication with the IoT device, and one or more multi-party computation (MPC) nodes in communication with the IoT device and the one or more MPC nodes. The data is encrypted using a blockchain process, and a symmetric key for the encrypted data is securely distributed via a MPC process to a data recipient.

In another aspect, the one or more blockchain nodes generates the symmetric key for a data type i for a time t and shares the symmetric key with the one or more MPC nodes and the IoT device.

In another aspect, the IoT device generates a data block of type i at time t and encrypts the data block along with a message authentication code using the symmetric key, and wherein the IoT device forwards encrypted data blocks of various data types to the one or more blockchain nodes.

In another aspect, the one or more blockchain nodes ensures that all received encrypted data blocks are generated by the IoT device by verifying the message authentication code.

In another aspect, upon verifying that the data recipient is allowed to access the data type i from the IoT device from time t, the one or more MPC nodes distributes the symmetric key to the data recipient.

In another aspect, the data recipient accesses data type i from the IoT device at time t from the blockchain and decrypts the encrypted data block.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system for protecting data privacy according to some embodiments of the present disclosure;

FIG. 2 is an illustration of a computer program product according to some embodiments of the present disclosure;

FIG. 3 is an illustration of a basic blockchain structure according to some embodiments of the present disclosure;

FIG. 4 is an illustration of a protocol overview according to some embodiments of the present disclosure;

FIG. 5 is an illustration of a block encryption key update according to some embodiments of the present disclosure; and

FIG. 6 is an illustration of arrangement of the components of the system for protecting data privacy according to some embodiments of the present disclosure.

### DETAILED DESCRIPTION

The present invention relates to a system for protecting data privacy and, more particularly, to a system for protecting data privacy using blockchain and multi-party computation. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of cited references is provided. Next, a description of the various principal aspects of the present invention is provided. Finally, specific details of various embodiment of the present invention are provided to give an understanding of the specific aspects.

(1) List of Incorporated Literature References

The following references are cited and incorporated throughout this application. For clarity and convenience, the references are listed herein as a central resource for the reader. The following references are hereby incorporated by reference as though fully set forth herein. The references are cited in the application by referring to the corresponding literature reference number, as follows:
1. Guy Zyskind, Oz Nathan, and Alex Pentland. Enigma: Decentralized Computation Platform with Guaranteed Privacy. https://enigma.co/enigma_full.pdf. Retrieved Mar. 30, 2018.
2. Damgård I., Nielsen J. B. Scalable and Unconditionally Secure Multiparty Computation. In: Menezes A. (eds) Advances in Cryptology—CRYPTO 2007. CRYPTO 2007. Lecture Notes in Computer Science, vol. 4622. Springer, Berlin, Heidelberg, 2007.
3. Satoshi Nakamoto. Bitcoin: A peer-to-peer electronic cash system, November 2008.
4. Aggrelos Kiayias, Alexander Russell, Bernardo David, and Roman Oliynykov. Outboros: A Provably Secure Proof-of-Stake Blockchain Protocol, August 2017.
5. Ralph Merkle. Protocols for Public Key Cryptosystems. In Proceedings of the IEEE Symposium on Research in Security and Privacy, pages 122-136, April 1980.

(2) Principal Aspects

Various embodiments of the invention include three “principal” aspects. The first is a system for protecting data privacy. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

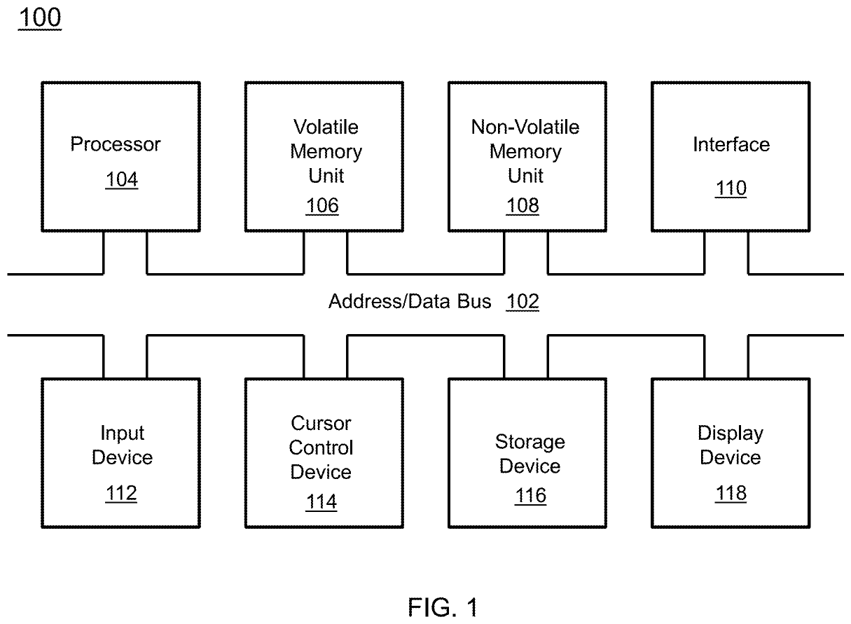

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

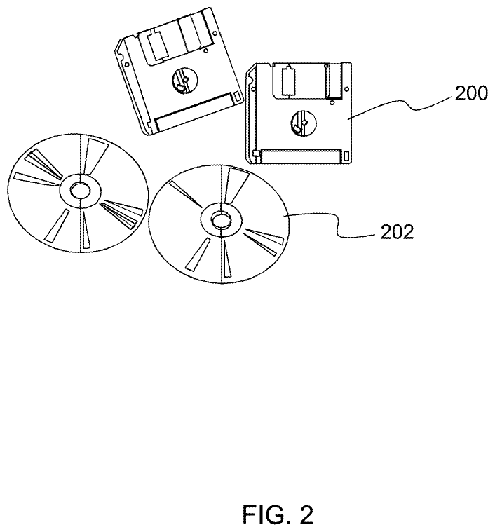

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(3) Specific Details of Various Embodiments

Described are systems and methods that protect data collected from a variety of devices with limited computational power and storage spaces. With the proliferation of smart and mobile Internet of Things (IoT) devices, including smart watches, smart home devices (e.g., thermometers, light bulbs, surveillance cameras, smart health monitoring devices (e.g., pacemakers, glucose meter)), and control units and sensors in smart cars, the amount of data generated is currently increasing, and the owners/users of these devices may neither be aware of all types of data that are being generated nor are guaranteed that the data is under their control. To help owners/users control privacy protection on their own data, the invention described herein utilizes blockchain and multi-party computation (MPC) such that users' data is securely stored with encryption using blockchain, and the decryption key for the encrypted users' data is securely distributed using MPC to those recipients that are authorized to access them.

A naïve solution requires centralized services that encrypt and store the user data and provide decrypted data to those with access permission; however, any failure in the centralized services does not guarantee availability of the data, and does not guarantee end-to-end privacy protection. Furthermore, devices collect different types of data, further complicating the process of storing and retrieving data in a secure way. As an example, a surveillance camera may collect two types of data: audio and video. More complex devices, such as an engine control unit of a smart car may collect coolant temperature, oxygen level, throttle position, air flow, etc.

A unique aspect of the approach according to embodiments of the present disclosure is that a variety of types of data is stored in a distributed network using blockchain in an efficient manner, and the key management and data access protocols guarantee to provide end-to-end privacy protection for specific data types, even for multiple, heterogeneous IoT devices that are limited by computational power and storage. The IoT is a network of physical devices, vehicles, home appliances, and other devices embedded with electronics, software, sensors, actuators, and Internet connectivity, which enables the devices to connect, communicate, collect, and exchange data with servers and/or other devices. The devices are embedded with technology which allows the devices to communicate over the Internet and be remotely monitored and controlled. The approach utilizes blockchain to store encrypted data and MPC to distribute decryption keys. Because of blockchain, the stored data is robust against a single point of failure and protected from modification or deletion. MPC also ensures resilience against node compromise to retrieve decryption keys.

(3.1) Blockchain and Multi-Party Computation (MPC)

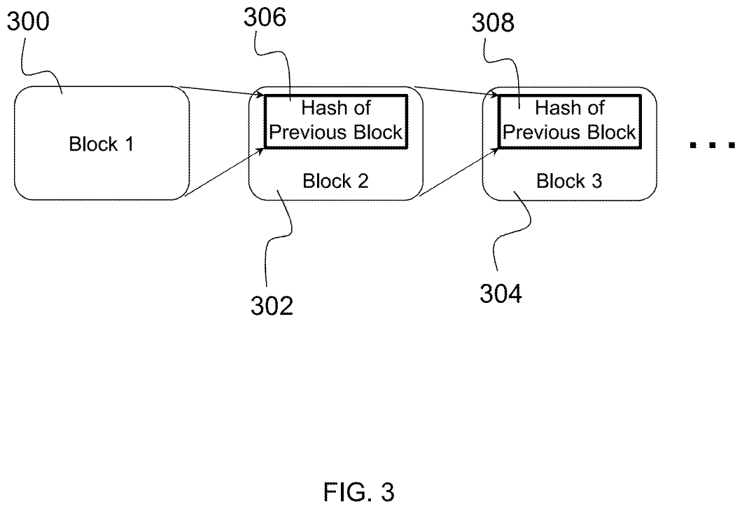

A blockchain is a collection of data that is segregated into a list of blocks. Each block is cryptographically linked to the previous block in such a way that one cannot edit a block without editing all subsequent blocks. This cryptographic linkage is normally achieved by including a hash digest of the previous block (or a hash digest of some portion of the previous block) in the subsequent block. A diagram of a basic blockchain structure is shown in FIG. 3, which depicts a Block 1 (element 300), a Block 2 (element 302), and a Block 3 (element 304) with Block 2 (element 302) and Block 3 (element 304) having a hash of the previous block (elements 306 and 308).

A blockchain is stored by a group of blockchain nodes. The block generation protocol will vary depending on the blockchain protocol being used, but once a new block is generated, it is sent to one or more of the blockchain nodes. The recipients then confirm that the received block is valid, and if so, they distribute it to other blockchain nodes; invalid blocks are ignored. It may take some time for all blockchain nodes to receive the new block, but it is expected that eventually all blockchain nodes will agree on the contents of a given block in the chain. The method by which the blockchain nodes reach a consensus on the contents of a given block will vary depending on the blockchain protocol.

A MPC protocol allows a group of servers to store secret data in a distributed fashion and perform computations on the distributed data without revealing the secret data to any individual server. Once the computation is complete, the servers can provide the output of the computation to one or more recipients. Blockchain and MPC nodes can be considered as servers that run the blockchain services and MPC protocols, respectively.

During the execution of a MPC protocol, some of the servers may become corrupted. A server corruption is any change that may cause the server to reveal secret data or to behave in a manner not specified by the protocol description. A server corruption could mean: that the server is infected with malware, which may allow an adversary to view all the server's data and cause the server to execute arbitrary code; that the server has lost or deleted data that it was supposed to keep; that the server has a hardware failure which causes unintended behavior; or that the server is experiencing network connectivity problems that prevent it from sending or receiving data properly.

MPC protocols are designed to be secure under the assumption that no more than a threshold number of servers are corrupted. The number of servers is denoted n and the corruption threshold is denoted t. This notation is common in MPC literature, and is used throughout this disclosure. For example, a MPC protocol may state that it is secure so long as less than one third of the servers are corrupted. In this case, the protocol requires that t<n/3, so that if, for instance, n=7, then the protocol would require that t is no more than 2, meaning that no more than 2 out of the 7 servers are corrupted. The specific values of n and t for the invention described herein will depend on the MPC protocol being used.

In this disclosure, MPC subprotocols are used to distribute private keys, and any MPC protocol from the literature will suffice (e.g., Literature Reference No. 2), so long as it contains subprotocols as described below.
1. Secret Sharing Protocol: A secret sharing protocol allows a dealer to distribute shares of a secret among a group of servers, and possibly deliver auxiliary information to the servers as well. Whether or not auxiliary information is included will depend on which subprotocol from the literature is being used.
2. Secret Reconstruction Protocol: A secret reconstruction protocol allows the servers to use their shares and possibly auxiliary information to reveal a secret to a recipient.

(3.2) Entities and Assumptions

In the system described herein, MPC subprotocols are used to distribute private keys, and any MPC protocol from the literature will suffice (e.g., Literature Reference No. 2), so long as it contains subprotocols as described below.

The approach according to embodiments of the present disclosure considers the storage and computational limitations on the devices that collect personal data (e.g., IoT devices), and utilizes several entities as follows.
1. Devices (S): A major functionality of these devices is to collect the data of their owners/users, including usage log, sensor readings, etc. When a device is activated for the first time, its user(s) may pair the device with its parent blockchain node (described below), and set up the data collection scheme in terms of the types of data to be collected, frequency, access permissions, etc. It is assumed that the device storage is limited, and hence may be unable to store all collected data. Non-limiting examples of devices include smart thermostats, smart doorlocks, and smart watches. It is also assumed that S has either a public-private key pair that can be used for secure communication with any other entity, or a pairwise secret key that it shares with a particular entity (e.g., BC nodes described below) for secure communication.
2. Blockchain (BC) nodes: These nodes store the data collected by devices S, and chains the data in blockchains. It is assumed that BC nodes have sufficient storage to maintain the blockchain, and each S has a parent BC node. Non-limiting examples of BC nodes include home WiFi routers, mobile phones, and servers including cloud servers. The owner may also define his/her mobile phone to be the parent BC node for his/her smartwatch. For those parent BC nodes without sufficient storage capacity to maintain the entire blockchain (e.g., mobile phone, WiFi routers), they may act as a relay to external BC nodes (e.g., cloud servers). It is assumed that each BC node has a public-private key pair for secure communication with anyone on the network, and that each parent BC node maintains a pairwise secret key with S for secure communication with S.
3. Multiparty computation (MPC) nodes: MPC nodes maintain keys to decrypt the private data from S. It is assumed that each MPC node has a public-private key pair.
4. Data recipient (D): In order to access the private data, recipient D must get an approval, either from S or BC nodes. If S is limited in editing the access permission through its own user interface (e.g., UI can only display information, no UI available), then data owners can modify the access permissions using their parent BC nodes, and BC nodes can share the access permissions with MPC nodes. With the appropriate access permission, D can acquire the decryption key for S's appropriate data type. It is assumed that D has a public-private key pair.
   For this disclosure, it is assumed that S and BC share a pairwise secret key to encrypt and decrypt their messages.

(3.4) Protocol

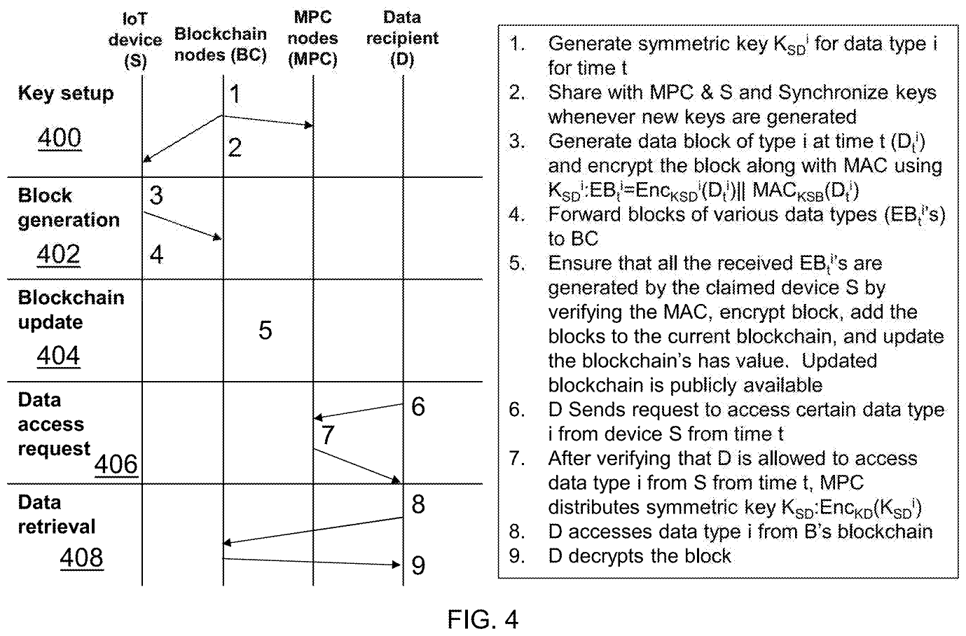

The protocol according to embodiments of the present disclosure is composed of five components: (1) key setup, (2) block generation, (3) blockchain update, (4) data access request, and (5) data retrieval. FIG. 4 illustrates the process and the message flows.

(3.4.1) Key Setup (Element 400)

Since it is assumed that S is limited in storage and computational power, users can use/assign the parent BC nodes to generate the symmetric key K_{SD}ⁱ that IoT device S and data recipient D will use to encrypt or decrypt data type i at time t, respectively. Then the parent BC nodes share K_{SD}ⁱ with S and MPC nodes securely (i.e., encrypt using the public key of S before sending to S, and the public key of the MPC nodes before sending to them).

(3.4.2) Block Generation (Element 402)

S collects data and generates data subblock of type i at time t (Dₜⁱ), and generates a message authentication code (MAC) on Dₜⁱ using the pairwise secret key K_{SB}, which is to prove to its parent BC node that S is the generator of the data subblock. Then S encrypts the data subblock and MAC to generate the encrypted block: EBₜⁱ=Enc_{KSD}ⁱ(Dₜⁱ)∥MAC_{KsB}(Dₜⁱ). Then S forwards EBₜⁱ for various data types to its parent BC node.

(3.4.3) Blockchain Update (Element 404)

Upon receiving EBₜⁱ, S's parent BC node can ensure that all the received EBₜⁱ's are generated by the claimed S by verifying the MAC. Once the MAC is verified to be correct, BC node adds the encrypted data subblock of type i to the queue. When a sufficient number of subblocks are in the queue, BC node creates a block. For example, current blockchain supports 1 megabyte (MB) as the maximum size of a single block. In this case, if each subblock is around 100 kilobytes (KB), having 10 subblocks would create 1 block. A “sufficient” number would be the number that satisfies to fill in >90% capacity of the block size, which is dependent on the size of each subblock and the maximum allowed size of a block.

The block consists of a list of encrypted data subblocks of different types from S, the root of the Merkle hash tree constructed using the subblocks (see Literature Reference No. 5 for an explanation of how a Merkle hash tree can be constructed), and the hash of the previous block in the blockchain. After creating the block, BC node adds the created block and updates its root hash value. The updated blockchain becomes publicly available and is shared with other blockchain nodes using any conventional consensus/mining methods (e.g., proof-of-work (see Literature Reference No. 3), proof-of-stake (see Literature Reference No. 4)).

(3.4.4) Data Access Request (Element 406)

Data recipient D sends a request to MPC nodes to access a certain data type i from device S from time t. MPC nodes then verify that D is allowed to access the data type i from S from time t. Then, following the general MPC protocols as described above, they distribute K_{SD}ⁱ after encrypting it using D's public key K_{D}: Enc_{KD}(K_{SD}ⁱ).

(3.4.5) Data Retrieval (Element 408)

When D acquires K_{SD}ⁱ, it can now access data type i generated by S at time t from the publicly-available blockchain by downloading the encrypted block (EBₜⁱ) and then using the public key (K_{SD}ⁱ) to decrypt the block and read the data.

(3.5) Block Encryption Key (K_{SD}ⁱ)

A crucial aspect for data privacy is to limit the duration of data access for each D as follows. For forward secrecy, if D₁ requests access to data type ED₁ from time t, D₁ should not be able to access ED₁ until time t. For backward secrecy, if D₂ loses access to data type ED₂ from time t, D₂ should not be able to access ED₂ from time t.

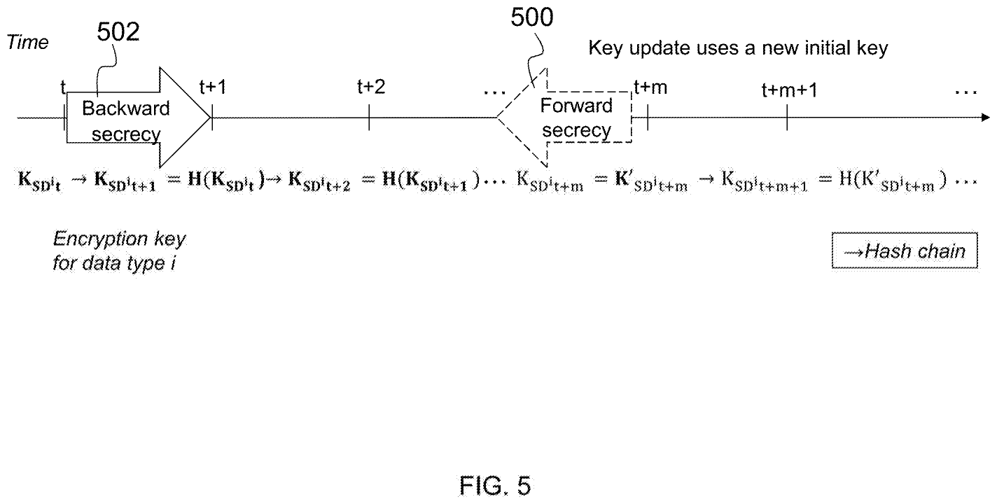

For efficiency, data recipient D should be prevented from requesting keys from the MPC nodes all the time. Hence, for each data type, the BC node encrypts it with an initial key K_{SD}ⁱ, and the key for the next block is a hash of the previous key in some canonical way (e.g., by using the hash to seed the pseudo-random generator used to generate the next key). In this manner, D only needs to query MPC nodes once to receive the initial key for data type i at time t, and continue accessing the same data type i until it loses access permission. If D loses access, a BC node updates the initial key to a different value, and either MPC servers redistribute the keys to other data recipients for the data type i (i.e., push keys), or recipients contact MPC to acquire the updated key (i.e., pull keys). FIG. 5 illustrates how the keys are chained to provide both forward secrecy 500 and backward secrecy 502.

In summary, the invention described herein provides privacy protection on user data collected from multiple, heterogeneous devices in an efficient manner without having a single point of failure. Enigma (see Literature Reference No. 1) combines blockchain and MPC to provide the feature called fully homomorphic encryption to enable entities to query encrypted data (i.e., query without first decrypting the data). However, Enigma suffers from computationally expensive cryptographic operations to query encrypted data, resulting in increased overhead on the order of 100× compared to querying non-encrypted data. The approach according to embodiments of the present disclosure is lightweight (i.e., computationally inexpensive) in cryptographic operations; the majority of the cryptographic operations to provide data privacy are based on symmetric-key encryption.

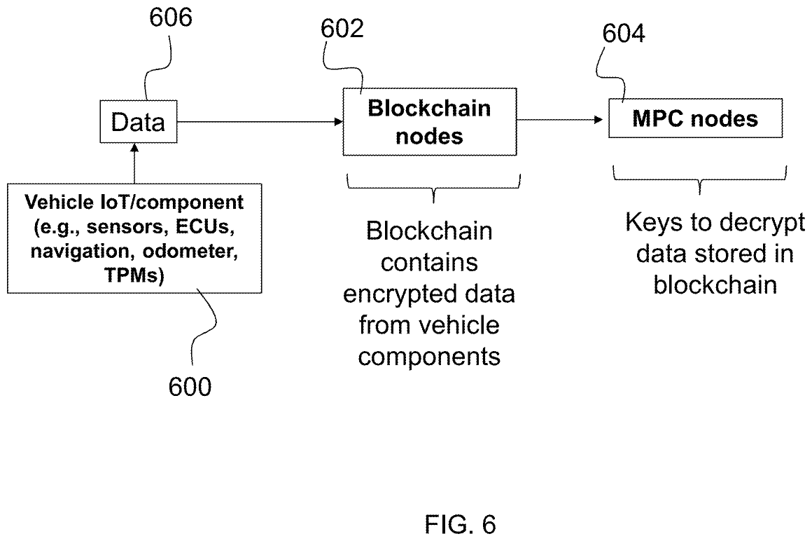

FIG. 6 depicts the arrangement of an IoT device 600, blockchain nodes 602, and MPC nodes 604. As one non-limiting example, vehicle manufacturers can benefit from the system described herein to protect the data collected from a vehicle IoT device 600 in an airplane or other vehicle (e.g., smart car), such as an engine control unit (ECU), a tire-pressure monitor (TPM), an odometer, and navigation sensors. An ECU is an electronic control unit controls a series of actuators on an internal combustion engine to ensure optimal engine performance. A TPM is an electronic sensor that monitors the air pressure inside tires on vehicles. A TPM can assist in avoiding traffic accidents, poor fuel economy, and increased tire wear due to under-inflated tires through early recognition of a hazardous state of the tires.

In particular, as both airplane and vehicle systems may handle data 606 from passengers and drivers, protecting their data 606 from unauthorized access is crucial. The MPC process (using MPC nodes 604, which are external to the vehicle) will ensure that only authorized entities will access the approved data 606 type, and the blockchain process (using blockchain nodes 602, which are external to the vehicle) ensures that the data is robustly available without access failure (i.e., does not require communication with a central, trusted server), and that the data 606 cannot be altered once recorded. Since each IoT device 600 can generate multiple data types (odometer data, ECU data, TPM data), granting someone to access the data generated by IoT device 600 “A” is insufficient to protect the privacy. Instead, the data owner should grant the entity to access certain type(s) of data from the IoT device 600. For instance, for vehicles, the owner may only allow the third-party insurance company to access the odometer data, but not the speed data.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for improved data privacy in Internet of Things (IoT) devices, the system comprising:
an IoT device having data stored thereon;
one or more blockchain nodes in communication with the IoT device; and
one or more multi-party computation (MPC) nodes in communication with the one or more blockchain nodes and the IoT device,
wherein the data is encrypted using a blockchain process using the one or more blockchain nodes, and
wherein a symmetric key for the encrypted data is securely distributed via a MPC process to a data recipient.

2. The system as set forth in claim 1, wherein the one or more blockchain nodes generates the symmetric key for a data type i for a time t and shares the symmetric key with the one or more MPC nodes and the IoT device.

3. The system as set forth in claim 2, wherein the IoT device generates a data block of type i at time t and encrypts the data block along with a message authentication code using the symmetric key, and wherein the IoT forwards encrypted data blocks of various data types to the one or more blockchain nodes.

4. The system as set forth in claim 3, wherein the one or more blockchain nodes ensures that all received encrypted data blocks are generated by the IoT device by verifying the message authentication code.

5. The system as set forth in claim 4, wherein upon verifying that the data recipient is allowed to access the data type i from the IoT from time t, the one or more MPC nodes distributes the symmetric key to the data recipient.

6. The system as set forth in claim 5, wherein the data recipient accesses data type i from the IoT device at time t from the blockchain and decrypts the encrypted data block.

7. A computer implemented method for improved data privacy in Internet of Things (IoT) devices, the method comprising acts of:
using a IoT device, one or more blockchain nodes in communication with the IoT device, and one or more multi-party computation (MPC) nodes in communication with the IoT device and the one or more blockchain nodes, encrypting data stored on the IoT device using a blockchain process, and securely distributing a symmetric key via a MPC process to a data recipient.

8. The method as set forth in claim 7, wherein the one or more blockchain nodes generates the symmetric key for a data type i for a time t and shares the symmetric key with the one or more MPC nodes and the IoT device.

9. The method as set forth in claim 8, wherein the IoT device generates a data block of type i at time t and encrypts the data block along with a message authentication code using the symmetric key, and wherein the IoT device forwards encrypted data blocks of various data types to the one or more blockchain nodes.

10. The method as set forth in claim 9, wherein the one or more blockchain nodes ensures that all received encrypted data blocks are generated by the IoT device by verifying the message authentication code.

11. The method as set forth in claim 10, wherein upon verifying that the data recipient is allowed to access the data type i from the IoT device from time t, the one or more MPC nodes distributes the symmetric key to the data recipient.

12. The method as set forth in claim 11, wherein the data recipient accesses data type i from the IoT device at time t from the blockchain and decrypts the encrypted data block.

13. A computer program product for improved data privacy in Internet of Things (IoT) devices, the computer program product comprising:
computer-readable instructions stored on a non-transitory computer-readable medium that are executable by a computer having one or more processors for causing the processor to perform operations of:
encrypting data on an IoT device based on a blockchain process using one or more blockchain nodes, wherein the one or more blockchain nodes are in communication with the IoT device, and
securely distributing a symmetric key for the encrypted data via a multi-party computation (MPC) process to a data recipient, the MPC process being based on one or more MPC nodes in communication with the one or more blockchain nodes and the IoT device.

14. The computer program product as set forth in claim 13, wherein the one or more blockchain nodes generates the symmetric key for a data type i for a time t and shares the symmetric key with the one or more MPC nodes and the IoT device.

15. The computer program product as set forth in claim 14, wherein the IoT device generates a data block of type i at time t and encrypts the data block along with a message authentication code using the symmetric key, and wherein the IoT device forwards encrypted data blocks of various data types to the one or more blockchain nodes.

16. The computer program product as set forth in claim 15, wherein the one or more blockchain nodes ensures that all received encrypted data blocks are generated by the IoT device by verifying the message authentication code.

17. The computer program product as set forth in claim 16, wherein upon verifying that the data recipient is allowed to access the data type i from the IoT device from time t, the one or more MPC nodes distributes the symmetric key to the data recipient.

18. The computer program product as set forth in claim 17, wherein the data recipient accesses data type i from the IoT device at time t from the blockchain and decrypts the encrypted data block.
